(19) United States
(12) Patent Application Publication
(10) Pub. No.: US 2004/0083193 A1
(43) Pub. Date: Apr. 29, 2004

(54) Expandable on-chip back propagation learning neural network with 4-neuron 16-synapse

(76) Inventors: Bingxue Shi, Beijing (CN); Chun Lu, Beijing (CN); Lu Chen, Beijing (CN)

Correspondence Address: J.C. Patents, Inc., Suite 250, 4 Venture, Irvine, CA, 92618, US

(21) Appl. No.: 10/283,478

(22) Filed: Oct. 29, 2002

(51) Int. Cl. G06G 7/00; G06E 3/00; G06E 1/00; G06N 3/04; G06F 15/18; G06N 3/08

(52) U.S. Cl. 706/26; 706/27; 706/25

(57) ABSTRACT

A expandable neural network with on-chip back propagation learning is provided in the present invention. The expandable neural network comprises at least one neuron array containing a plurality of neurons, at least one synapse array containing a plurality of synapses, and an error generator array containing a plurality of error generator. An improved Gilbert multiplier is provided in each synapse where the output is a single-ended current. The synapse array receives a voltage input and generates a summed current output and a summed neuron error. The summed current output is sent to the input of the neuron array where the input current is transformed into a plurality of voltage output. These voltage output are sent to the error generator array for generating a weight error according to a control signal and a port signal.

### BACKGROUND OF THE INVENTION

1. Field of the Invention

The present invention relates to a neural network; and more particularly, to an expandable on-chip learning neural network.

2. Description of Related Art

A perceptron is a neural network invented in 1940's, which has a multilayer structure. In general, when the number of layer is one it is a single layer perceptron and when the number of layers is larger than 2 it is called a multi-layer perceptron.

In general, a perceptron usually accepts multiple inputs, multiplies the input each by a weight, sums the weighted inputs, then subtracts a threshold, and limits the resulting signal, and so on by passing it through a hard limiting nonlinearity. This perceptron can be combined into multiple perceptron networks which is a type of artificial neural networks. These networks generally comprised intercoupled perception layers having multiple input, intermediate and output neurons. Artificial neural networks currently are used in artificial intelligence (Al) applications such as pattern recognition and classification and robotic movements.

A neural-network basis apparatus having the functions of computing operations, storage, learning and the like has been realized by circuits and operation means, which are modeled on each neuron. The fact that most of the outputs of nerves become the inputs of other nerves has been well known. Also in the neural-network basis apparatus, the output signal of the circuit and the operation means, which are modeled on a neuron, frequently become the input signal of the circuit and operation means, which are modeled on another neuron. By convention, a neural network is constructed by combining those neuron circuits and operation means.

The neuron linearly multiplies the signals from other neurons in accordance with a strength of bonding of synapses for transferring the signals, adds the results of multiplying operations from the synapses of the neuron to the threshold value of the neuron, and transfers the output signals, which are equivalent to the results of the process carried out by the nonlinear function, to other neurons, through the synapses. The conventional art constructs the neuron circuits and operation means in a similar order. The synapses of each neuron are constructed by a circuit corresponding to a linear multiplier circuit, invented by Gilbert. The output currents of the synapses are added together. Then, a nonlinear characteristic is gained by a differential amplifier. The current is converted into a corresponding voltage, which is then used as an output signal of the neuron. A neural circuitry based on the neural circuitry theory is constructed by connecting the circuits modeled on the neurons. When carefully studying the Gilbert multiplier circuit, it is seen that the multiplier circuit is made up of a multiplier core circuit and a circuit for correcting the nonlinearity of the multiplier core circuit. These circuits each include a circuit for converting a voltage difference into a current difference. Generally, this voltage-to-current converting circuit suffers from an appreciable error. The circuit including diode-coupled transistors also suffers from an appreciable error arising from a variation of the characteristics of the elements, which is caused during the manufacturing process. Therefore, it is impossible to perfectly correct the nonlinearity of the multiplier core circuit. The Gilbert multiplier circuit is attendant with an error, although appreciable. For this reason, an error owing to the nonlinearity is observed in the multiplier characteristic. The nonlinear function circuit using the differential amplifier, which is coupled to the output of the multiplier circuit, also causes an error. The nonlinear function circuit is influenced by temperature of the elements. The input sensitivity of the circuit is proportional to absolute temperature. Consequently, the characteristic of the overall neural network also varies. When a signal passes through multiple stages of circuits, the error is accumulated to increase. In an extreme case, it is next to impossible to realize desired functions. Therefore it is necessary to provide an improved version of the Gilbert multiplier.

The multi-layer perceptron has extremely high complex data processing capability. These on-chip learning neural network chips are powerful and robust which make them ultimately suitable for systems demanding high speed, small volume, and reduced weight. The parameters of the perceptron are given by the summation of weights of the synapse junction between neurons. As a result, a self-governing or adaptive type network can be constructed by updating these parameters according to the partial differential equations called the learning equations. More recently, the research and development in the areas of feed-forward neural network with on-chip learning and back propagation learning is very intense and emphasized.

Neural networks can implemented into different scaled according to different situations. A general-purpose neural network must be expandable in order for it to be applicable and practical. As a result, a novel expandable chip structure is provided in the present invention without the need of additional output and therefore higher density of the entire network is realized.

The neuron is the kernel of an artificial neural network. It is used to realize nonlinear transformations. For the on-chip back-propagation learning, both a non-linear function and its derivative are required. The neuron circuit can realize the sigmoid function with programmable threshold and gain factor. The neuron can alternatively realize the derivative of the sigmoid function using the central differential method. It has a push-pull output stage to gain strong driving ability in both charge and discharge processes.

A multiplier in a synapse (a junction containing two neurons) is the most repeated block of any neural network. The Gilbert multiplier device is very widely used for the multiplier in a synapse due to its low power dissipation, high density, and good input symmetry. However the Gilbert amplifier also has disadvantages such as small linear range and unstable zero point. As a result, an improved multiplier is required for increased robustness.

Various solutions have been provided for the implementations of general-purpose neural networks with on-chip learning BP learning. Some of the conventional neural networks have been discussed in the following references:

Berg. Y, Sigvartsen R. L., Lande T. S. and Abusland A., 1996, An analog feed-forward neural network with on-chip learning. Analog Integrated Circuits and Signal Processing, 9, 65-75.

Dolenko B. K., and Card H. C., 19995, Tolerance to analog hardware of on-chip learning in backpropagation networks. IEEE Trans. On Neural Networks, 6(5), 1045-1052.

Morie T., and Amemiya Y, 1996, An all-analog expandable neural-network LSI with on-chip back-propagation learning. IEEE Trans. Neural Networks, 7(2) 346-361.

Valle M. Caviglia D. D., and Bisio G. M., 1996, An analog VLSI neural network with on-chip back propagation learning. Analog Integrated Circuits and Signal Processing, 9, 231-245.

Morie T. and Amemiya Y. (1996) proposed an expandable LSI neural network with on-chip back-propagation learning. However auxiliary output units are needed to construct a complete on-chip learning system in this structure.

### SUMMARY OF THE INVENTION

It is an object of the present invention to provide an expandable neural network with on-chip BP learning.

It is an object of the present invention to provide an expandable neural network that does not require additional outputs to maintain the density of the network.

It is a further object of the present invention to have neuron circuit that can realize the sigmoid function with programmable threshold and gain factor.

It is a further object of the present invention to provide a neural network with an improved Gilbert multiplier with increased performance and robustness.

In order to achieve the above objects, the present invention provides a multi-layer perceptron circuit device.

A expandable neural network with on-chip back propagation learning is provided in the present invention. The expandable neural network comprises at least one neuron array containing a plurality of neurons, at least one synapse array containing a plurality of synapses, and an error generator array containing a plurality of error generator. Improved Gilbert multipliers are provided in each synapse where the output of each multiplier is a single-ended current. The synapse array receives a voltage input and generates a summed current output and a summed neuron error. The summed current output is sent to the input of the neuron array where the input current is transformed into a plurality of voltage outputs. These voltage outputs are sent to the error generator array for generating a weight error according to a control signal and a port signal.

It is to be understood that both the foregoing general description and the following detailed description are exemplary, and are intended to provide further explanation of the invention as claimed.

### BRIEF DESCRIPTIOIN OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of the circuit architecture of the neural network according to the preferred embodiment of the present invention.

FIG. 2A is a schematic diagram of the neuron according to the preferred embodiment of the present invention.

FIG. 2B is a schematic diagram of the synapse according to the preferred embodiment of the present invention.

FIG. 2C is a schematic diagram of the error generator according to the preferred embodiment of the present invention.

FIG. 3 is a schematic diagram of a multi-chip configuration neural network according to the preferred embodiment of the present invention.

FIG. 4 is a circuit diagram of the neuron according to the preferred embodiment of the present invention.

FIG. 5 is a circuit diagram of the multiplier according to the preferred embodiment of the present invention.

FIG. 6A is a graph of voltage vs. current of a neuron according to the preferred embodiment of the present invention.

FIG. 6B is a graph of current vs. voltage of a synapse according to the preferred embodiment of the present invention.

FIG. 7 is a graph illustrating waveforms of successful parity-3 learning according to the preferred embodiment of the present invention.

### DETAILED DESCRIPTION OF THE PREFERRED EMBODIEMENTS

FIG. 1 is a schematic diagram of the structure of the expandable on-chip BP learning network. It comprises a neuron array, a synapse array, and an error generator array, wherein the neuron array comprises a plurality of neurons, the synapse array comprises a plurality of synapses, and the error generator array comprises a plurality of error generators. According to the preferred embodiment, there are 4 neurons (denoted as N in the diagram), 16 synapses (denoted as S in the diagram), and 4 error generator units (denoted as E in the diagram). In VLSI neural networks, a single neuron is always coupled to a plurality of synapses and is usually coupled to one error generator unit. Large-scale neural networks with arbitrary layers and discretional neurons per layer can be constructed by combining a plurality of these chips together.

In FIG. 1, a group of input voltage “Xᵢₙ” is sent to all the input of the n synapses of the neural network according to the original matrix, wherein “Xᵢₙ” represents a group of voltage (Xᵢ₁, Xᵢ₂, Xᵢ₃ . . . ) The synapses multiply the input voltage “Xᵢₙ” with a weight “w” to generate a signal “m” which is summed to get an output current signal “sⱼ”. The output current signal “sⱼ” is sent to the input of the 4 neurons. The neuron generates a plurality of output voltage signals “x”, “x1”, and “x2” according to the sigmoid function from the following equation (1). The output voltage signals “x” are the output signal “Xₒᵤₜ” of the neural network. The output voltage signals “x”, “x1”, and “x2” are sent to the input of the error generator together with a control signal “c” and a port signal “t/eᵢₙ” to generate an error signal “d” which is sent back to the 16 synapses.

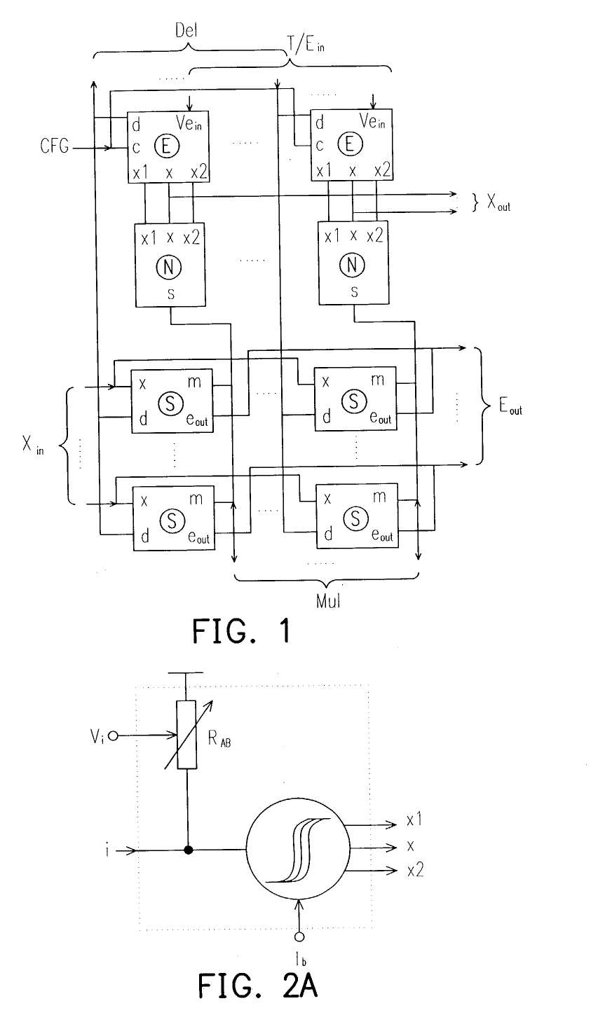

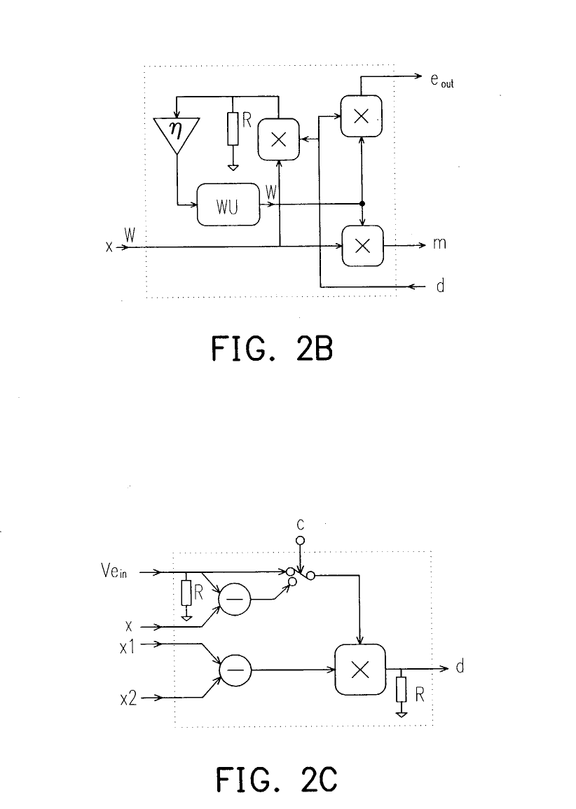

FIG. 2A is a schematic diagram of the neuron. It transforms a current input “s” to a voltage output “x” according to a sigmoid function with programmable gain and threshold. The sigmoid function can be expressed by equation (1):

$$f ( s ) = \frac{1}{1 + {ⅇ}^{- α ( s + θ )}}$$

where α is the gain factor, θ is the threshold, and s is the sum of the weighted inputs. By using the central differential method, an approximate derivative of the transfer function is achieved by subtracting the output x2 from x1.

FIG. 2B is a schematic diagram of the synapse. A synapse block performs three functions: a.) multiplying a weight “w” by a weight error signal “d” to generate a signal eₒᵤₜ”, which is coupled to a summing ling “eᵢ” in the current domain to get a neuron error signal eᵢ=Σⱼwᵢⱼdᵢⱼ b.) multiplying a weight “w” by an input “x” to generate a signal “m”, which is coupled to a summing line “sⱼ” in the current domain to get a signal sⱼ=Σᵢwᵢⱼxᵢ c.) updating a weight “w” by a weight unit (WU) which uses a capacitor as a memory.

FIG. 2C is a schematic diagram of the error generator unit. The error generator unit takes input signals “x”, “x1”, and “x2” and control signal “c” and port control signal “t/eᵢₙ” to output a weight error signal “d”, wherein the control signal “c” decides whether the corresponding neuron is an output neuron and the port control signal “t/eᵢₙ” is a twofold port. If c=1, a target value “t” is imported to the “t/eᵢₙ” port and “d” is obtained by multiplying (t-x) with (x1-x2); if c=0, a neuron error value “eᵢₙ” is imported to the “t/eᵢₙ” port and “d” is obtained by multiplying “eᵢₙ” with (x1-x2). So no additional output chips are required to construct the whole on-chip learning system.

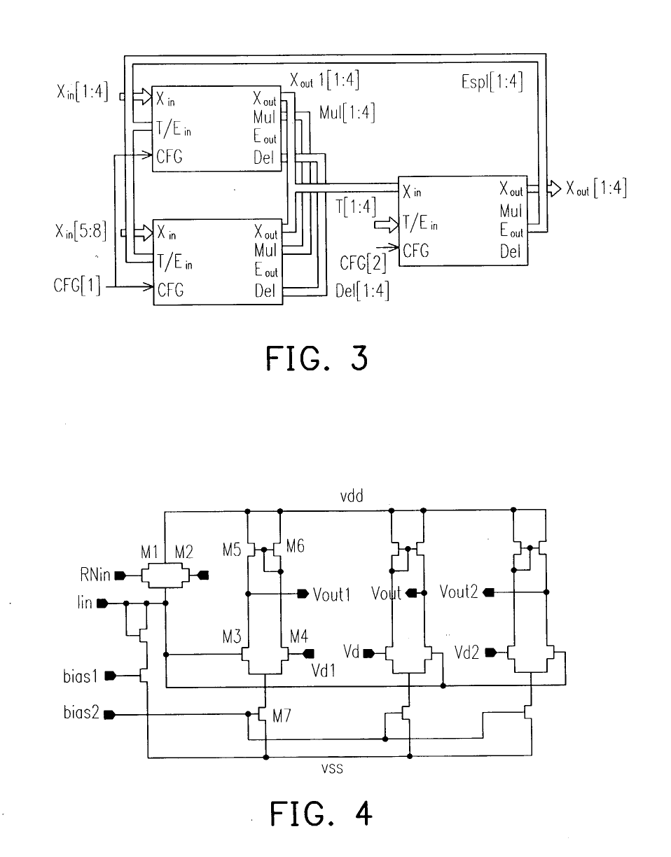

FIG. 3 shows an 8N-4N multi-chip configuration neural network according to the preferred embodiment but the configuration of the chips is not limited to any structure or number of chips. An on-chip learning system with 8 input neurons and 4 output neurons is provided. Xᵢₙ [1:8] are the input signals, T[1:4] are the target signals, and Xₒᵤₜ [1:4] are the output signals of the neural network. The configuration signal CFG[1] is equal to 0 for the input layer and CFG[2] is equal to 1 for the output layer. Epsl[1:4] are the feedback error signals. Xₒᵤₜ[1:4] are the output signals of the input layer and the input signals of the output layer. Mul[1:4] includes 4 signals, in which each is a sum of 8 weighted input signals. Del[1:4] also includes 4 signals, in which each connects to 8 “d” ports of a synapse block. As a result, no auxiliary output unit chip is necessary. In general, in order to construct a iN-jN-kN neural network, (┌i/4┐x┌j/4┐+┌j/4┐x┌k/4┐) unit of chips are required.

FIG. 4 is a circuit diagram of the neuron according to the preferred embodiment of the present invention. The generated sigmoid function is expressed by equation (1). In the circuit, “vdd” is a 0.9V power supply and “vss” is a −2.5V power supply. “RNin”, “RPin”, “bias1”, “bias2”, “Vd”, “Vd1“, and “Vd2” are all fixed bias voltages, where Vd2-Vd=Vd-Vd1=ΔV, ΔV is a small positive voltage. “Iᵢₙ” is an input current. Vout outputs the sigmoid activation function. (Vout1-Vout2) realizes its approximate derivative by using the central difference method. The gain factor α can be varied by changing the control voltages “RNin” and “RPin”. The threshold θ can be adjusted by changing the reference voltage “bias1”.

In this heavy load situation, the transient performance is rather important. In the proposed neuron circuit, the transistors M3 and M5 realize the push-pull output stage of the neuron to gain strong driving ability in both directions.

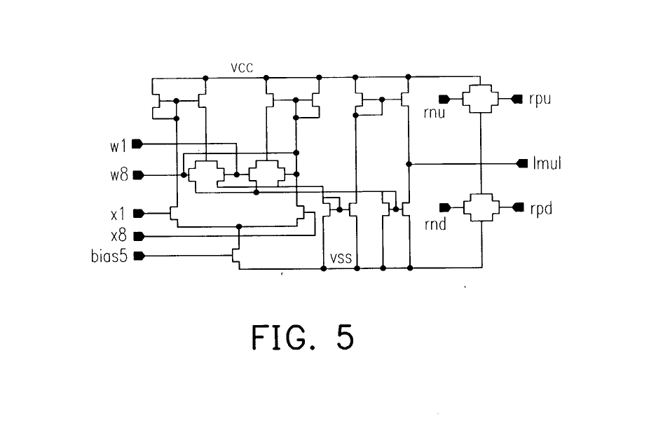

FIG. 5 is a schematic diagram of the improved multiplier. It is an improved version of the widely used Gilbert multiplier. “vcc” and “vss” are respectively a 2.5V and a −2.5V power supply. “bias” is a bias voltage. “w1”, “w0”, “x1”, and “x0” are input differential voltages. Voltages signals are chosen as inputs because outputs of neurons have to be distributed to a plurality of synapses. This one-to-many distribution can best be realized by representing the input of a synapse with a voltage. The output of the synapse is a current “Imu1”. The synapse output is represented by a current due to the necessary summation of all synapse outputs coupled to the same neuron.

As compared to the Gilbert multiplier, one improvement is that the output of these synapses having improved Gilbert multiplier is a single ended current, whereas the output of the original Gilbert multiplier is a current difference. In a neural network implementation, a single-ended input of a synapse has the advantage of less communication lines between neurons and synapses. This improvement also optimizes the linearity of the multiplier.

Another improvement is that two MOS formed resistors controlled by voltages “rnu”, “rpu”, “rnd”, and “rpd” are added to the output stage to compensate the offset of the zero point of multiplier. This offset is inevitable because the simulation model is not precisely extracted and that the simulation results are sensitive to the models. Under the ideal situation, the control voltages “rnu”, “rpu”, “rnd”, and “rpd” are selected that there is no current passes through the MOS formed resistors. If the tested zero point of the multiplier has offsets, the transistors which form the resistors are turned on to compensate the offset.

It can be seen from the figure that a NMOS is controlled by “rnu” and a PMOS is controlled by “rpu”. The bigger the value of “rnu”, the larger the current runs through the NMOS. The smaller the value “rpu”, the larger the current runs through the PMOS. The same are as the “rnd” and “rpd”. So if the zero point has no offset, “rnu” and “rnd” are set to vss. “rpu” and “rpd” are set to vcc so that there is not any current runs through these four transistors. If there is a negative offset, “rnu” is adjusted to a higher voltage and “rpu” to a lower voltage so that a current running through the MOS transistors controlled by “rnu” and “rpu” compensates the offset. If there is a positive offset, “rnd” is adjusted to a higher voltage and “rpd” to a lower voltage so that the current running through the MOS transistors controlled by “rnd” and “rpd” compensates the offset.

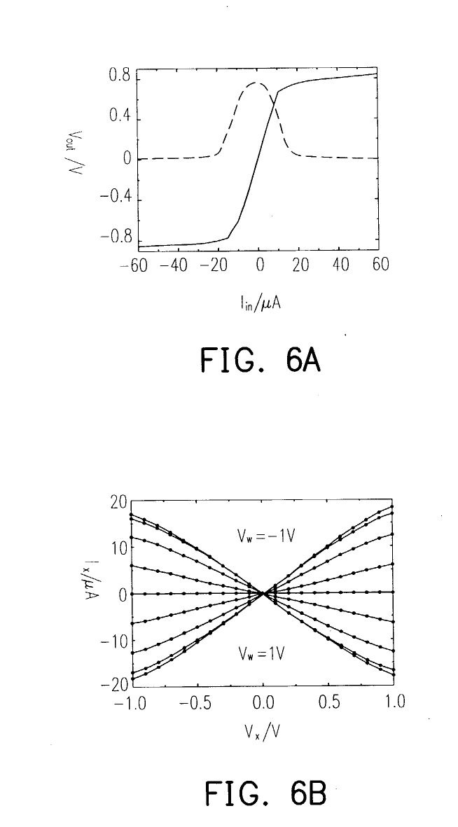

FIG. 6A shows the measured results of a neuron unit occupying an area of 43×60 μm² with a power consumption of 475 μW. The solid line is the generated sigmoid function and the dash line is the generated derivative function. Both the relative error between the generated activation function and the ideal sigmold curve and the relative error between the generated derivative function and the ideal derivative curve are less than 5%.

FIG. 6B shows the results of a multiplier occupies an area of 82×33 μm² with a power consumption of 112 μW. Measured result of the transfer characteristics of the multiplier. The non-linearity of the synapse is less than 6% within the input range [−1, 1].

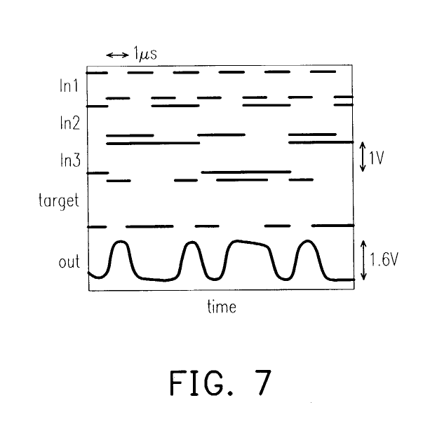

A 2-layer on-chip BP learning neural network is constructed to perform parity experiments. The system can accomplish learning a parity-3 problem within 2 ms with a capacitor memory, conclusion can be drawn that the learning system itself can be used as a refresh tool to keep the weight value right. Waveforms of the result of the parity-3 problem are shown in FIG. 7 with the pattern presentation rate of 1 MHz. It can be seen that the on-chip learning system can solve the parity problem properly.

An expandable general-purpose neural network with on-chip BP learning prototype is designed and fabricated with a standard 0.5 μm CMOS, double-poly, double-metal, technology. A programmable neuron and an improved Gilbert multiplier are proposed. It uses capacitor-type memory and a full-parallel architecture. Measured results show that these building blocks have good performance. Successful parity recognition experiments show that the proposed neural network works well for on-chip BP learning.

TABLE 1
Characteristics of the prototype chip

| Parameter | Description |
|---|---|
| Forward propagation time | 0.3 μs |
| Backward propagation time | 0.3 μs |
| Computation rate | 50 MCPS |
| Fabrication process | 0.5 μm CMOS double-metal |
| Synapse unit size | 81 × 32 μm² |
| Chip size | 2.7 × 1.6 mm² |
| Power dissipation | 10 mW |
| Package | 48-pin DIP |

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A expandable on-chip learning neural network comprising:
at least one neuron array containing a plurality of neurons, wherein each neuron transforms a current input to a voltage output according to a sigmoid function with a programmable gain and a threshold;
at least one synapse array containing a plurality of synapses, wherein each synapse stores a weight, generates a single-ended current and a neuron error, and updates a weight value by a built-in weight unit; and
at least one error generator array containing a plurality of error generators, wherein each error generator generates an error according to a control signal and a port signal.

2. The neural network in claim 1, wherein the programmable gain is varied by changing control voltages and the threshold is varied by changing a reference voltage.

3. The neural network in claim 1, wherein the synapse further comprises an improved Gilbert multiplier and the output of the Gilbert multiplier is a single-ended current which can be summed up.

4. The neural network in claim 1, wherein the synapse array can learn by back propagation learning algorithm by updating and comparing the weight values.

5. The neural network in claim 1, wherein the neural network is readily expandable into a multi-chip configuration.

6. The neural network in claim 1, wherein the neural network is fabricated using CMOS, double-poly, and double-metal technology.
